(19) United States
(12) Patent Application Publication
(10) Pub. No.: US 2026/0366362 A1
(43) Pub. Date: Nov. 19, 2026

(54) PASSIVE FLOOD BARRIER SYSTEM FOR UNDERGROUND OPENINGS

(71) Applicants: Preston Scott Painter, Grand Forks, ND (US); James Paul Satrom, Grand Forks, ND (US); Daniel Thomas Satrom, Arvilla, ND (US); Grant Lucas Satrom, Grand Forks, ND (US); Patrick John Warren, Grand Forks, ND (US); Peter Allen Letvin, Emerado, ND (US); Nathan Joel Ueland, Grand Forks, ND (US)

(72) Inventors: Preston Scott Painter, Grand Forks, ND (US); James Paul Satrom, Grand Forks, ND (US); Daniel Thomas Satrom, Arvilla, ND (US); Grant Lucas Satrom, Grand Forks, ND (US); Patrick John Warren, Grand Forks, ND (US); Peter Allen Letvin, Emerado, ND (US); Nathan Joel Ueland, Grand Forks, ND (US)

(21) Appl. No.: 19/455,440

(22) Filed: Jan. 21, 2026

Related U.S. Application Data
(60) Provisional application No. 63/751,980, filed on Jan. 31, 2025.
(60) Provisional application No. 63/880,051, filed on Sep. 11, 2025.
(60) Provisional application No. 63/951,899, filed on Dec. 31, 2025.

(51) Int. Cl. E06B 9/00; E02B 3/10

(52) U.S. Cl. CPC E06B 9/00; E02B 3/10; E06B 2009/007

(57) ABSTRACT

The present invention relates to a passive flood barrier system configured to protect underground openings from flooding while permitting airflow under non-flood conditions. The system comprises a barrier assembly housing at least one movable panel, a counterbalancing mechanism, a water flow regulation system, a debris management system, and a self-resetting mechanism. The movable panel remains stowed during normal conditions and transitions to a deployed position when water accumulation exceeds a predefined threshold. The counterbalancing mechanism facilitates controlled movement of the panel, while the water flow regulation system manages water ingress to prevent premature activation. Upon recession of floodwaters, the self-resetting mechanism returns the panel to its stowed position, restoring airflow. The system operates without external power or manual intervention, utilizing passive mechanical forces for activation and reset, making it a reliable solution for flood protection in urban environments.

### CLAIM OF PRIORITY

The present application is based on and a claim of priority is made under 35 U.S.C. Section 119(e) to a provisional patent application that is currently pending in the U.S. Patent and Trademark Office, namely, that having Ser. No. 63/751,980 and a filing date of Jan. 31, 2025. This application is also based on and a claim of priority is made under 35 U.S.C. Section 119(e) to a provisional patent application that is currently pending in the U.S. Patent and Trademark Office, namely, that having Ser. No. 63/880,051 and a filing date of Sep. 11, 2025. This application is also based on and a claim of priority is made under 35 U.S.C. Section 119(e) to a provisional patent application that is currently pending in the U.S. Patent and Trademark Office, namely, that having Ser. No. 63/951,899 and a filing date of Dec. 31, 2025, all of which are incorporated herein by reference in their entireties.

### BACKGROUND OF THE INVENTION

### Field of the Invention

The present invention relates generally to flood protection systems, and more particularly to a passive, mechanical flood barrier system designed for underground or ground level openings such as subway vents. The system operates autonomously without external power sources, utilizing water's weight to deploy sealing panels that prevent flooding while maintaining ventilation and debris filtering functionality.

### Description of the Related Art

Flooding is a persistent and widespread issue affecting urban infrastructure, particularly in areas where underground structures such as subway systems, utility tunnels, and basements are present. These structures, by design, are highly susceptible to water ingress due to their below-ground placement, open ventilation systems, and reliance on underground passageways for air circulation. During heavy rainfall, storm surges, or failures in municipal drainage systems, water can rapidly accumulate in these underground spaces, leading to severe damage, disruptions in essential services, and increased safety risks for occupants and maintenance personnel. Effective flood mitigation solutions are necessary to prevent water from entering these underground areas, as even small amounts of flooding can cause electrical malfunctions, structural degradation, and operational delays that impact thousands of people and critical infrastructure.

Numerous flood protection strategies have been implemented to mitigate these risks, ranging from manually operated flood barriers to automated gate systems and inflatable flood walls. While these approaches can provide a degree of protection, they each suffer from inherent drawbacks that limit their effectiveness and reliability in real-world flooding scenarios. Manually operated barriers, for instance, require human intervention to deploy, which may not be feasible in emergency conditions where flooding occurs rapidly or during periods when maintenance personnel are unavailable. Flooding events often develop unpredictably, leaving little time for manual deployment, and any delays can lead to severe damage before protective measures take effect. Additionally, personnel responsible for deploying these barriers may be placed at risk if they must access flooded areas to engage the protective systems.

Some flood protection systems rely on inflatable or mechanically actuated barriers that deploy automatically when water levels reach a certain threshold. While these systems can provide improved response times compared to manually operated barriers, they frequently depend on external power sources, compressed air systems, or hydraulics to function. This reliance on external energy sources presents a major vulnerability, as power failures are common during extreme weather events, rendering these systems inoperable when they are needed most. Even when backup power is available, mechanical failures, sensor malfunctions, or obstructions in the deployment path can prevent these barriers from activating properly, leaving underground openings exposed to water infiltration.

In addition to issues related to deployment reliability, many existing flood protection solutions struggle with debris management. During flood events, large volumes of debris including leaves, plastic waste, branches, and sediment-are carried by moving water. When flood barriers lack effective debris handling mechanisms, this material can become lodged in deployment components, preventing the barrier from sealing properly or obstructing its ability to activate. In some cases, debris accumulation can cause partial deployment, where only a portion of the barrier is engaged, leaving gaps through which water can enter the protected space. Even if a barrier deploys fully, trapped debris can interfere with its ability to return to a stowed position after the floodwaters recede. This results in increased maintenance demands, requiring personnel to manually clear the barrier before it can function properly again.

Another significant challenge associated with many flood protection systems is their inability to reset automatically after deployment. Many traditional barriers, once engaged, remain in the deployed position until they are manually reset. This poses a major operational issue in urban environments where underground infrastructure, such as subway systems, must resume function as quickly as possible following a flood event. If a barrier remains engaged after the immediate flood threat has passed, it can block ventilation, restrict pedestrian or vehicular access, and require labor-intensive procedures to return it to its stowed configuration. In cases where resetting the barrier involves heavy lifting, mechanical unlocking, or specialized equipment, operational downtime may be prolonged, leading to disruptions in essential services and economic losses. The need for manual intervention also increases operational costs, as maintenance teams must be dispatched to reset and inspect the system after each deployment.

Flood protection measures must also take into account the need for continuous airflow in underground environments. Many existing flood mitigation solutions are designed to fully seal openings to prevent water ingress, but in doing so, they may also obstruct necessary airflow to protected structures for longer periods of time than necessary, requiring advanced shut downs of critical infrastructure. Underground transit systems, electrical vaults, and tunnels rely on ventilation shafts to regulate air quality, temperature, and pressure. When flood barriers block these openings, airflow is reduced or completely shut off, potentially leading to overheating of electrical systems, accumulation of hazardous gases, or reduced air circulation for passengers and workers. In many applications proactive deployment of flood barriers in advance of a potential flooding risk can restrict access and egress through openings, but may also require utilities or transit systems to be shut down due to restricted airflow or access to critical spaces. Manually deployed flood barriers require even longer periods of down time due to the labor intensive and time intensive deployment and stowage process. Other flood barriers use powered louvers or mechanical vent covers that close when a flood is detected, but these solutions add mechanical complexity, require electrical power, and may fail due to sensor malfunctions or mechanical wear.

The weight and bulk of many flood protection systems also pose installation challenges, particularly in retrofitting existing infrastructure. Some traditional barriers require extensive modifications to existing vent shafts, entryways, or tunnels to accommodate large flood gates, reinforced walls, or mechanical lifting devices. In many cases, these modifications are costly and may not be feasible in historically significant or structurally constrained areas. Furthermore, some barriers require permanent structural changes that may interfere with existing drainage systems, underground utilities, or other critical infrastructure elements. These challenges make it difficult for many urban centers to implement effective flood mitigation solutions without significant investments in construction and ongoing maintenance.

Additionally, cost considerations play a significant role in the adoption of flood mitigation solutions. Many flood barrier systems, particularly those that rely on automated mechanical deployment, require expensive materials, specialized installation procedures, and regular maintenance to ensure long-term reliability. Cities and private infrastructure operators may be reluctant to invest in systems that demand high initial costs and ongoing maintenance expenditures, especially if alternative solutions are available that provide partial protection at a lower cost. However, lower-cost solutions often come with trade-offs in terms of reliability, durability, and ease of deployment, leaving many underground facilities with inadequate or unreliable flood protection.

Given the limitations of existing flood mitigation approaches, there is a need for a more effective system that can provide reliable, automatic flood protection without reliance on external power, manual intervention, or complex mechanical components. Such a system should be capable of deploying in response to rising water levels without requiring human activation, ensuring that flood protection is always available when needed. Additionally, an ideal flood barrier should incorporate an effective debris management feature that prevents obstructions from interfering with deployment while allowing incidental debris to be flushed away to maintain continued operation and reducing recurring maintenance costs.

To further enhance functionality, a flood protection system should be able to reset itself after deployment without requiring manual intervention. This would ensure that the system remains operational for future flood events without necessitating maintenance personnel to manually lift, unlock, or reposition the barrier after each use. Additionally, such a system should allow for normal airflow or access through underground openings when no flooding is present, preserving ventilation while maintaining readiness for flood protection.

A solution that integrates these characteristics-automatic deployment, debris management, self-resetting capability, and ventilation preservation-would provide significant advantages over conventional flood mitigation strategies. By addressing the drawbacks of existing approaches, a more efficient and cost-effective flood protection system could reduce infrastructure damage, minimize economic losses, and improve the long-term resilience of underground spaces. Implementing such a system would help cities, transit authorities, and private operators better prepare for extreme weather events, ensuring the safety and functionality of critical infrastructure while reducing maintenance costs and operational disruptions.

### SUMMARY OF THE INVENTION

The present invention relates to a fully passive flood barrier system designed to protect underground openings or other openings that may be submerged by flood waters such as subway vents, utility shafts, and basements from flooding events. The system operates without external power, utilizing the weight of water to automatically deploy sealing panels that form a watertight barrier against incoming floodwaters. Under normal conditions, the panels remain in a stowed position, allowing for unrestricted airflow through the protected opening. The system incorporates a metering station that regulates water inflow into the deployment mechanism, ensuring that the barrier only activates when water intrusion into the opening exceeds a predefined flow rate. Additionally, an integrated debris management mechanism filters out solid particles, preventing clogging and ensuring consistent functionality. Once the floodwaters recede, the system self-resets, returning to its stowed position without requiring manual intervention. This allows for continuous operation, ensuring that the structure remains protected from subsequent flooding events while maintaining ventilation or access when dry conditions prevail.

This invention provides several advantages over existing flood protection systems, which often rely on mechanical actuators, external power sources, or manual deployment. Many conventional barriers require human intervention, which can be impractical during rapidly developing flood events or when personnel are unavailable. Systems that depend on electricity or hydraulics introduce potential failure points, particularly in extreme weather conditions where power outages are common. Additionally, barriers that lack effective debris management can become obstructed, preventing proper deployment and requiring extensive recurring maintenance. The present invention eliminates these challenges by functioning entirely through passive mechanical principles, ensuring reliability even in emergency conditions. By integrating a self-resetting mechanism, the system eliminates the need for post-flood manual repositioning, reducing downtime and operational costs. Furthermore, the ability to maintain normal airflow when in the stowed position makes it particularly suitable for applications where ventilation is essential. This combination of features results in a flood protection system that is not only highly effective but also low-maintenance, durable, and well-suited for urban environments.

In one implementation of the present invention, a passive flood barrier system for protecting an underground opening from floodwater while allowing access or airflow under non-flood conditions is provided. The system comprises a barrier assembly configured to cover the underground opening, the barrier assembly including at least one movable panel configured to transition between a stowed position during non-flood conditions and a deployed position during a flood event to form a seal over the underground opening. A counterbalancing mechanism is operatively connected to the movable panel, the counterbalancing mechanism configured to retain the movable panel in the stowed position and permit deployment in response to water accumulation exceeding a predefined threshold. The system further includes a water flow regulation system configured to control water entry into the movable panel, wherein the water flow regulation system allows water into the movable panel when water intrusion exceeds a predefined threshold while preventing premature activation due to minor water intrusion. A debris management system is integrated with the barrier assembly, the debris management system configured to direct or filter solid debris away from the movable panel or water flow regulation system. In yet another example, a self-resetting mechanism is further provided, the self-resetting mechanism configured to return the movable panel from the deployed position to the stowed position after floodwaters recede, restoring airflow through the underground opening. The passive flood barrier system operates without requiring external power or manual intervention, utilizing the weight of accumulated water to activate deployment and a restoring force to facilitate reset after the flood event.

In a second aspect, the passive flood barrier system may further comprise a pivotally mounted movable panel, wherein the movable panel rotates between the stowed position and the deployed position.

In another aspect, wherein the counterbalancing mechanism may include at least one spring, counterweight, or torsion element configured to resist movement of the movable panel until the weight of accumulated water exceeds a predetermined threshold.

In another aspect, wherein the counterbalancing mechanism may provide a restoring force to return the movable panel to the stowed position after floodwaters recede.

In another aspect, the passive flood barrier system may further comprise a water flow regulation system, wherein the water flow regulation system controls water entry into the movable panel, wherein water intruding into the underground opening passes through the water flow regulation system and is diverted away from the movable panel until the intruding water exceeds a rate which warrants deployment of the movable panel, at which point water is diverted into the movable panel.

In another aspect, the water flow regulation system may include a metering chamber with at least one orifice, baffle, weep hole, flow control valve, or controlled water outlet to delay deployment until a sufficient flow rate of intruding flood water has been exceeded. The metering chamber may contain a reservoir volume where entering flood water is diverted away from the movable panel through at least one lower positioned calibrated drainage port consisting of an orifice, baffle, weep hole, flow control valve, or controlled water outlet until the rate of entering flood water exceeds the drainage port flow rate, causing water to accumulate in the reservoir volume where it is enabled to divert to the movable panel to facilitate deployment via upper positioned holes or overflow of the metering chamber volume.

In another aspect, the passive flood barrier system may further comprise a debris management system, wherein the debris management system is configured to filter or redirect solid debris away from the movable panel or water flow regulation system to prevent obstruction of the deployment or retraction mechanism.

In another aspect, wherein the debris management system may include a mesh screen, perforated plate, or sediment diversion channel to prevent clogging of the deployment system.

In another aspect, wherein the movable panel, when in the deployed position, may form a substantially watertight seal with a sealing interface.

In another aspect, wherein the sealing interface may include a compressible gasket, wiper seal, or inflatable seal to enhance water resistance.

In another aspect, the passive flood barrier system may further comprise a self-resetting mechanism, wherein the self-resetting mechanism is configured to facilitate removal of residual water after the flood event to enable the counterbalancing mechanism to return the movable panel to the stowed position.

In another aspect, wherein the self-resetting mechanism may include a drainage pathway with at least one weep hole, siphon, or controlled discharge outlet.

In another aspect, wherein the passive flood barrier system may further comprise multiple movable panels that are interconnected such that deployment of one panel triggers deployment of at least one adjacent panel.

In another aspect, wherein the interconnected movable panels may be linked via a mechanical linkage, hydraulic transfer system, or synchronized buoyant activation mechanism.

In another aspect, there is fluid partition in the barrier assembly housing located between the multiple panels, allowing independent deployment and function of each panel of the passive flood barrier system.

In another aspect, the fluid partition includes a fluid passageway to enable accumulating water above a first deployed panel to be routed into the second movable panel to facilitate deployment of the second movable panel.

In another aspect, the passive flood barrier system may have only one movable panel.

In another aspect, wherein the barrier assembly may be modular, allowing for installation over openings of various shapes and sizes.

In another aspect, wherein the barrier assembly may be constructed from corrosion-resistant materials, including stainless steel, aluminum, or polymer composites.

In another aspect, wherein the system may be configured to maintain airflow through the underground opening when in the stowed position.

In another aspect, wherein the system may be configured to operate without requiring external power or manual intervention.

In another implementation of the present invention, a method for passively preventing floodwater ingress into an underground opening is provided. The method includes installing a passive flood barrier system over the underground opening, wherein the system comprises at least one pivotally mounted movable panel, a counterbalancing mechanism, a water flow regulation system, a debris management system, and a self-resetting mechanism. Under non-flood conditions, the movable panel remains in a stowed position, allowing airflow through the underground opening. In flooding conditions as water enters the passive flood barrier system, the debris management system works to exclude debris from water that is collected and funneled to the water flow regulation system. The water flow regulation system meters the inflow to ensure controlled activation of the barrier. When sufficient flow rate of flood water becomes present, the water flow regulation system allows water to enter and accumulate in the movable panel. When the accumulated water within the movable panel exceeds a predefined threshold, the weight of the water overcomes the resistance of the counterbalancing mechanism, causing the movable panel to transition from the stowed position to a deployed position, forming a substantially watertight seal over the underground opening. Once the floodwaters recede, the self-resetting mechanism facilitates drainage through at least one weep hole, siphon or controlled discharge outlet, enabling the counterbalancing mechanism to return the movable panel to the stowed position, thereby restoring airflow through the underground opening. The method operates entirely without external power or manual intervention, relying solely on passive mechanical forces to activate, deploy, and reset the flood barrier system.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents an isometric view of a passive flood barrier system, shown in a closed position, in accordance with an illustrative embodiment of the present invention;

FIG. 2 presents an isometric view of the passive flood barrier system illustrated in FIG. 1, shown in an open position;

FIG. 3 presents a top view of the passive flood barrier system illustrated in FIG. 1, shown in a closed position;

FIG. 4 presents a top view of the passive flood barrier system illustrated in FIG. 1, shown in an open position;

FIG. 5 presents a bottom view of the passive flood barrier system illustrated in FIG. 1, shown in a closed position;

FIG. 6 presents a bottom view of the passive flood barrier system illustrated in FIG. 1, shown in an open position;

FIG. 7 presents a back view of the passive flood barrier system illustrated in FIG. 1, shown in an open position;

FIG. 8 presents a front view of the passive flood barrier system illustrated in FIG. 1, shown in an open position;

FIG. 9 presents a left-side view of the passive flood barrier system illustrated in FIG. 1, shown in an open position;

FIG. 10 presents a right-side view of the passive flood barrier system illustrated in FIG. 1, shown in an open position;

FIG. 11 presents an isometric view of the passive flood barrier system including a catch pan structure, providing an alternate view focused on the structural configuration and lower drainage integration, in accordance with an additional illustrative embodiment of the present invention;

FIG. 12 presents an isometric view of the passive flood barrier system without the catch pan, illustrating an alternate configuration where the barrier housing terminates in a narrowed base profile, omitting the lower retention structure;

FIG. 13 is a top-front perspective view of a passive flood barrier system installed within an existing structure, with a grating positioned above the barrier and a semi-transparent outline of the surrounding environment shown for clarity to illustrate the system's ability to activate automatically in response to rising water levels;

FIG. 14A illustrates a top view of an elevated bridge deck installation in which multiple modular flood barrier panels are arranged in a linear configuration along the deck surface;

FIG. 14B illustrates an isometric view of the elevated bridge deck installation of FIG. 14A, further showing a structural support beneath the deck;

FIG. 14C illustrates a front view of the elevated bridge deck installation of FIG. 14A;

FIG. 14D illustrates a side view of the elevated bridge deck installation of FIG. 14A;

FIG. 14E is an enlarged isometric view of an example bridge deck implementation with portions of the surrounding support structure removed to expose an array of flood barrier modules positioned beneath the deck;

FIG. 15A is a top view of the flood barrier system, illustrating a pair of internal rain louvers mounted over a recessed catch basin, with surrounding perimeter gutters;

FIG. 15B is an isometric view of the flood barrier system of FIG. 15A, showing the relative positioning of the internal rain louvers, catch basin, and upper flanges;

FIG. 15C is a front view of the flood barrier system, illustrating a downward tapering housing structure terminating in a drain stub, with louvers positioned above the catch basin;

FIG. 15D is a side view of the flood barrier system of FIGS. 15A-15C, showing the stacked rain louvers within the sidewall profile, as well as the flange interface and drain stub outlet;

FIG. 16 is a sectional view illustrating an example implementation of the flood barrier system in a stowed configuration, in which a pair of flood barrier panels are housed within a recessed cavity below a drainage assembly comprising a metering chamber, wherein the panels are configured to remain hidden until activated; and

FIG. 17 is a sectional view similar to FIG. 16 but showing the flood barrier panels in a deployed configuration, wherein the panels have pivoted outward from the recessed cavity to form a barrier extending above the drain surface, with sealing gaskets engaging corresponding sealing surfaces to prevent water ingress.

Like reference numerals refer to like parts throughout the several views of the drawings.

### DETAILED DESCRIPTION OF THE PREFERRED EMBODIMENT

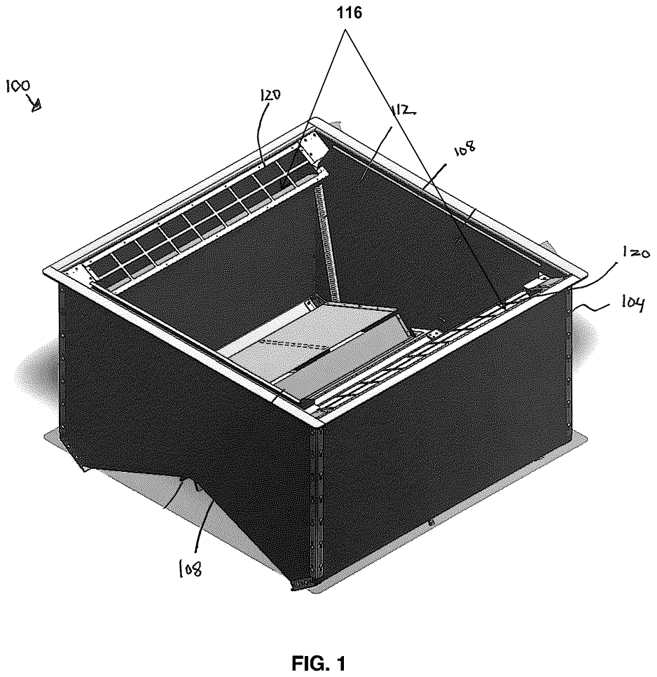

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, a passive flood barrier system is designed to provide automatic flood protection for underground openings such as subway vents, utility shafts, and basements. This system utilizes the hydrostatic weight of accumulating floodwater to trigger the deployment of sealing panels, creating a watertight barrier that prevents water from entering protected structures. Unlike conventional flood barriers that require electrical power or manual operation, the system functions autonomously using passive mechanical forces, making it highly reliable in emergency situations. The design ensures that under normal, dry conditions, the system remains unobtrusive, allowing air to circulate freely through the underground opening. When floodwaters recede, the system automatically resets, restoring ventilation without requiring human intervention. The system is particularly well-suited for urban environments where sudden and heavy rainfall can overwhelm drainage systems, leading to flash flooding.

FIG. 1 illustrates a passive flood barrier system 100 in its closed or deployed position. A flange positioned around at least a portion of the top of flood barrier system 100 can overlap onto the perimeter existing structure of a ground opening to provide a means of mounting or supporting the flood barrier system. The flange enables the product to be installed flush with or below the floor surface. Often flood barrier system 100 can be installed within ground openings in roadways or sidewalks where grating can be installed to cover the ground opening and flood barrier system 100, demonstrating its seamless integration with the surrounding environment to avoid obstructing pedestrian and vehicle traffic. A means of sealing the flood barrier to the existing structure can be implemented. In one example a gasket, sealant, or the like can be placed on the flange or upper portion of the barrier assembly housing to make a watertight seal with the existing structure.

The movable panels 108 are key operational components of the system, held in place by a counterbalancing mechanism 112, which includes carefully selected and calibrated springs, counterweights, or torsion bars. These elements are engineered to provide the necessary force to keep the panels securely stowed, yet allow them to deploy swiftly when triggered by sufficient water accumulation. This mechanism is important for the system's responsiveness, ensuring that the panels move quickly and smoothly into position to form an effective barrier during flooding. Detailed engineering of the counterbalancing mechanism 112 must be performed to ensure that mechanism can maintain the panel in the stowed position in dry conditions, and yet allow the gravitational induced moment from the weight of the movable panel 108 and water accumulation to trigger deployment of the panel in flood conditions. Additional engineering considerations must be accounted for in the design of the counterbalancing mechanism 112 and the movable panel 108 to ensure the panel fully deploys from the stowed to the deployed position when initial deployment motion is induced by accumulating water weight, so that the panel does not get suspended partial way to its deployed position or flutter between a stowed and deployed state as the accumulated water within the panel drains out and refills once back into the stowed position. One way to achieve full rotation of the panel into the deployed position is to ensure the counterbalancing mechanism is engineered so the rotational moment that induces deployment of the panel continues to increase as the panel rotates toward the deployed position. This can be achieved by ensuring the gravitationally induced moment of the weight of panel and accumulated water within the panel remains larger than the rotational moment the counterbalancing mechanism imparts onto the panel, throughout the full deployment swing of the movable panel. A similar design criteria is important when flood conditions recede, wherein the panel must rotate from the deployed position entirely to the stowed position without delay, so the panel may be in a position to catch and accumulate water if flood conditions become present again. As an example, after a flood scenario has receded, the self-resetting mechanism 130 allows drainage of barrier assembly 104 and movable panel 108. When a sufficient amount of water has drained from the movable panel 108, movement of the panel to the stowed position results as the rotational moment from the gravitational forces of the panel weight and remnant accumulated water within the movable panel is no longer sufficient to overcome the rotational moment imparted by the counterbalancing mechanism. Throughout the full angular swing of the panel from the deployed to the stowed position, the counterbalancing mechanism can be designed such the rotational moment it imparts on the panel remains larger than the gravitationally induced moment of the panel and any remnant accumulated water within the panel.

Additional considerations can be designed to provide surplus forces for deployment and stowage to overcome non-ideal field conditions such as frictional forces or debris accumulation. This can be accomplished by designing excess water accumulation volume within the panel to provide more robust deployment forces, and surplus counterbalancing mechanism forces to return a panel to a stowed position when the panel is drained (via self-resetting mechanism).

Other technical design elements must be considered in the design of the counterbalancing mechanism. If the counterbalancing mechanism consists of a tension spring, this design element must account for the varying force of a spring as it is elongates as the movable panel rotates. Similar design variables exist when other type of counterbalancing mechanism are used, such as a torsion spring or counterweight and pulley arrangement. The counterbalancing mechanism must also be engineered to account for the dynamic geometry that results with rotation of the movable panel and the angle at which the counterbalancing mechanism 112 interacts with the movable panel through its range of motion. The varying geometry ultimately affects the rotational moment the counterbalancing mechanism imparts onto the movable panel throughout its movement.

A water flow regulation system can be incorporated to prevent deployment of the passive flood barrier system until a sufficient amount of water enters the underground opening. In some applications of the passive flood barrier system it may be preferred that the flood barrier remain in the stowed position throughout rain or run-off events that do not pose a flooding hazard. A water flow regulation system can divert water away from the movable panel 108, until the flow rate of intruding water warrants deployment of the passive flood barrier system, wherein the waterflow regulation system diverts intruding water into the movable panel 108 to instigate deployment. In some embodiments, the movable panel may define one or more internal chambers, cavities, or compartments configured to receive and temporarily store water. The chambers may be sized or shaped to control the rate of water accumulation and to generate a desired moment or torque sufficient to rotate the movable panel toward the deployed position. To capture and route intruding water toward the water flow regulation system, a gutter system can be implemented around some of the perimeter of the barrier assembly housing. In certain embodiments, portions of the movable panel may include buoyant elements, sealed volumes, or low-density materials arranged such that water accumulation within the panel produces a combined buoyant and gravitational force that biases the panel toward deployment once a predetermined water level is reached.

Additionally, in some embodiments, the water flow regulation system may be entirely passive and self-regulating, requiring no external power, sensors, or controls. Deployment may occur solely as a function of hydraulic flow rate, water level, pressure differential, or combinations thereof.

In another aspect, a water flow regulation system may be integrated into the movable panel. The movable panel may include a drainage port positioned proximate a lower portion thereof and sized to permit evacuation of water entering the panel so as to inhibit deployment under low-flow conditions. When the inflow rate of water entering the movable panel exceeds the evacuation capacity of the drainage port, water accumulates within the panel to a level sufficient to cause the movable panel to rotate from a stowed position to a deployed position.

In certain embodiments, the movable panel may include a plurality of drainage ports positioned at different elevations within the panel. One or more of the drainage ports may be configured to evacuate water during low-flow conditions, while one or more higher-elevation drainage ports may become submerged or otherwise ineffective as water levels rise, thereby promoting accelerated water accumulation within the panel to initiate deployment.

In some embodiments, the drainage port may include a flow-restricting element, such as an orifice plate, valve, baffle, or labyrinth passage, configured to control the rate at which water exits the movable panel. The flow-restricting element may be fixed or adjustable to permit tuning of a deployment threshold corresponding to a desired water inflow rate or water depth.

In some embodiments, the drainage port may be configured to become partially or fully occluded in response to increasing water flow, debris, sediment, or pressure differential. Such occlusion may reduce the effective drainage capacity of the port and facilitate water accumulation within the movable panel under high-flow conditions. In another embodiment, a mechanism may restrict or close the drainage port once water level within the panel exceeds a certain level.

In other embodiments, the water flow regulation system of the movable panel may include a drainage port restriction device configured to partially or fully restrict the drainage port when the movable panel rotates to the deployed position. Restricting the drainage port in the deployed position may be advantageous to retain water within the movable panel for an extended duration following deployment.

In some embodiments, the drainage port may become covered, obscured, or otherwise blocked by a portion of a barrier assembly housing, frame, or sealing interface as the movable panel rotates into the deployed position. In certain embodiments, the restriction device may include a gasket or sealing element positioned to create a substantially watertight closure of the drainage port when the movable panel is deployed.

In some embodiments, the drainage port restriction device may be mechanically actuated by movement of the movable panel, a hinge assembly, or a counterbalance mechanism as the movable panel transitions from a stowed position to the deployed position.

In other embodiments, the drainage port restriction device may be actuated in response to water accumulation within the movable panel. Activation may occur when water reaches a predetermined level within the panel and may be initiated by hydrostatic pressure, buoyancy, or movement of a mechanical element positioned at the predetermined level. Prior to reaching the predetermined level, the restriction device remains inactive, allowing the drainage port to evacuate water from within the movable panel and thereby inhibiting unwarranted deployment of the movable panel.

In some embodiments, the relative sizing of the drainage port and internal volume of the movable panel may be configured to produce a delayed deployment response, such that the movable panel deploys only after sustained water inflow over a predetermined time period, thereby reducing nuisance deployment from transient splashing, wave action, or brief rainfall events.

In some embodiments, the drainage port may be configured to permit gradual evacuation of water from the movable panel after flood conditions subside, allowing the panel to return from the deployed position to the stowed position without manual intervention.

In addition, a debris management system 120 plays a significant role in the functionality of the flood barrier, featuring protective screens or perforated plates that filter out debris, ensuring that components, like the movable panels 108, are free from obstructions that could impede their deployment. This system helps maintain the reliability of the flood barrier, particularly in environments where storms can carry significant amounts of debris. Completing the system's features, a self-resetting mechanism 130 is designed to automatically revert the barrier to its original stowed position after the floodwaters have receded, using the natural drainage of water to activate the reset. This feature is important for the sustainability of the system, reducing the need for manual intervention and ensuring that the barrier is always ready for the next flood event, thereby enhancing the system's readiness and resilience in urban flood-prone areas.

In some embodiments, the debris managements system could be incorporated to prevent debris from entering the movable panel. The debris managements system can incorporate a mesh, screen, perforated plate, or sediment diversion channel location on or proximate to the movable panel to exclude debris from water entering the movable panel.

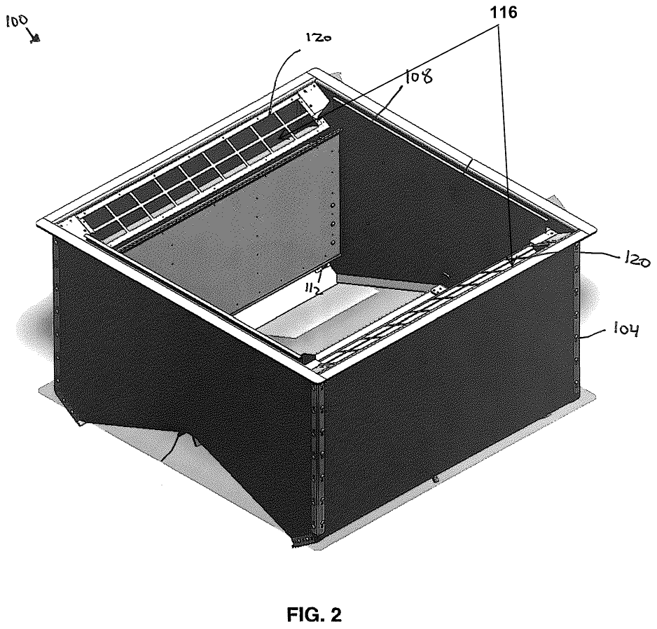

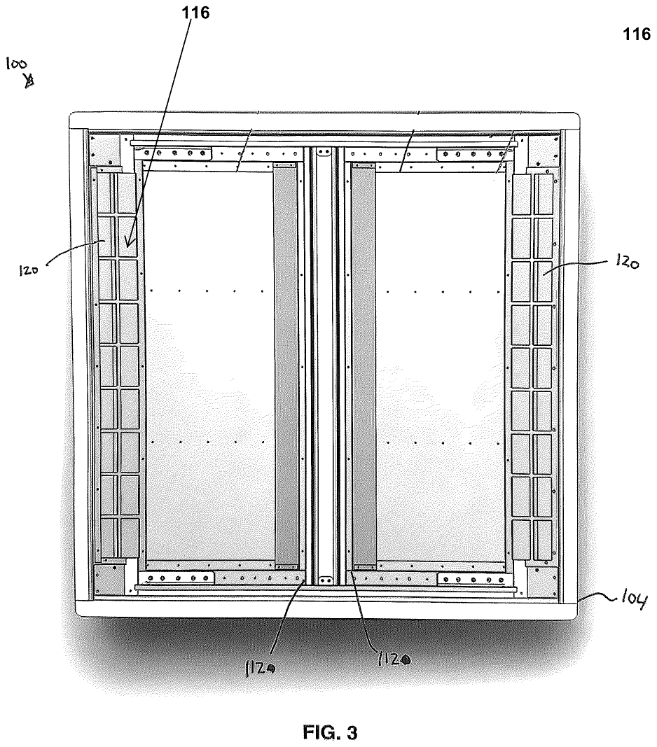

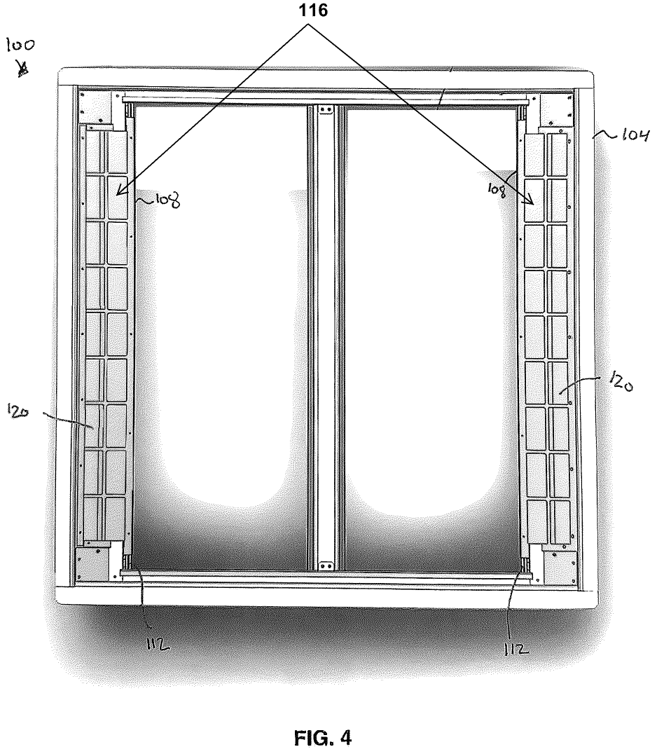

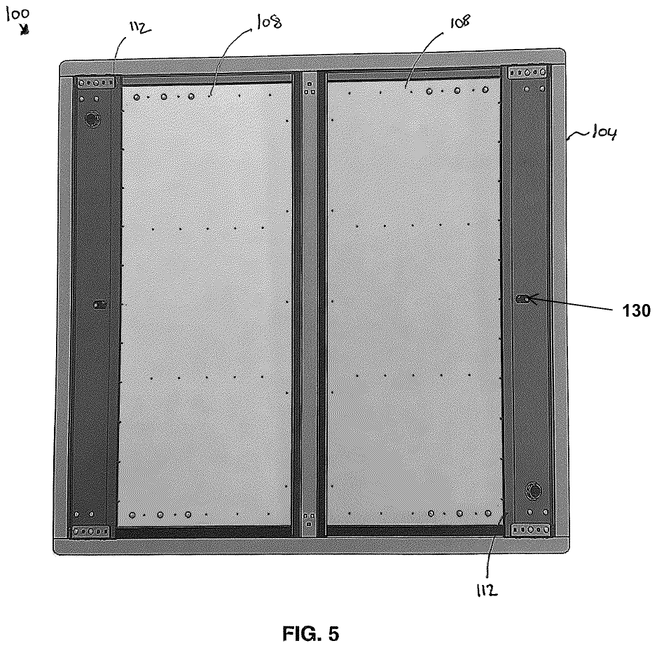

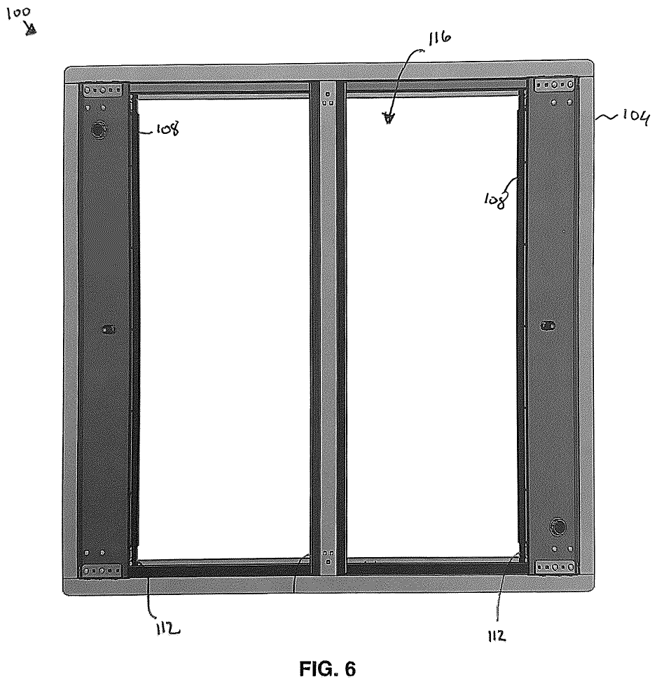

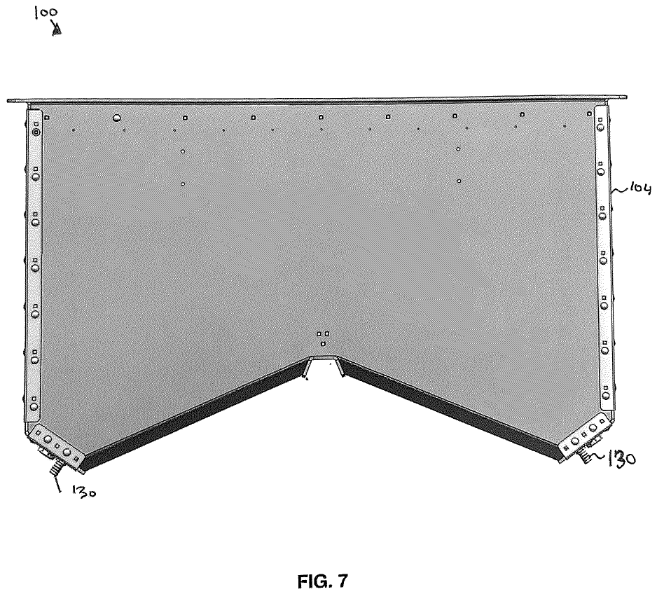

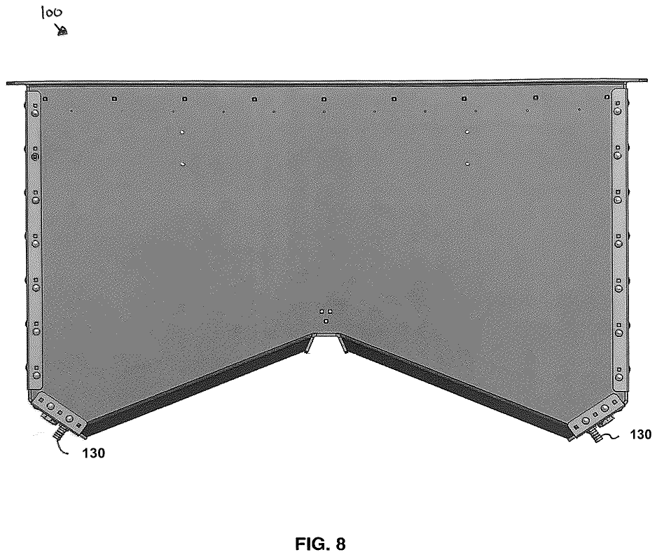

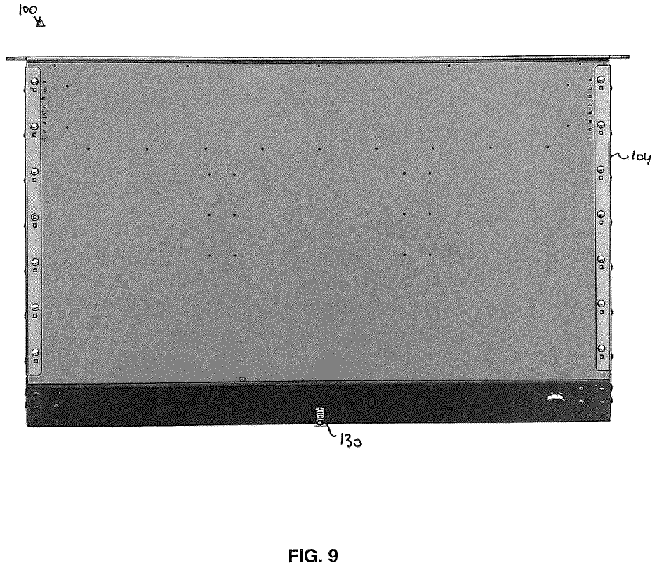

As shown in FIGS. 2 through 10, the passive flood barrier system 100 may be implemented across a range of configurations that govern panel deployment, water intake, drainage flow paths, and counterbalance operation. In general, a movable panel 108 is designed to rotate downward from a vertical stowed position into a deployed barrier position in response to rising floodwater. Fluid ingress may be controlled through a variety of metering approaches, including internal orifices, baffled intake chambers, or passive dampers. Some versions incorporate internal structures to direct water flow and facilitate drainage after deployment. Counterbalance mechanisms may be integrated beneath or within the footprint of the installation and are tuned to allow smooth, predictable rotation of the panel. These mechanisms are housed in vaults or a barrier assembly housing that can be installed curbside or within sidewalks and are typically fabricated from corrosion-resistant materials such as steel, aluminum, or high-strength composites for long-term durability.

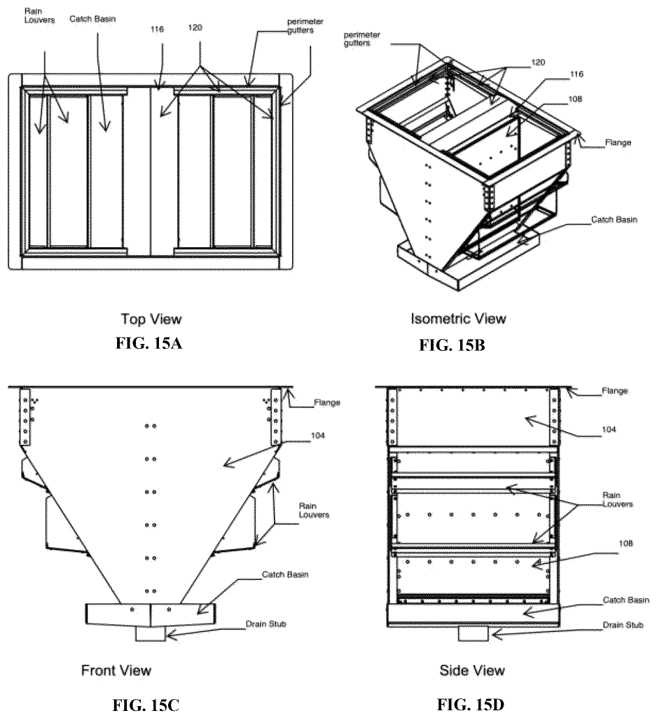

Referring to FIGS. 15A through 15D, the flood barrier system 100 incorporates a prefabricated vault or barrier assembly housing 104 designed for installation within built environments, including curbs, sidewalks, and other urban surfaces. The vault 104 is formed as a modular housing unit with side flanges extending laterally to engage with adjacent infrastructure. These flanges provide a stable mounting interface with poured concrete, pavers, or structural slabs, contributing to positional stability and sealing integrity. Within the vault's central cavity, a movable panel 108 is positioned in a generally vertical orientation during the stowed condition and is rotatably mounted to allow pivoting under hydrostatic force. The panel 108 is mechanically coupled to an internal counterbalance mechanism 112 located within the vault body, dimensioned to provide sufficient resistive force to maintain the panel upright under normal conditions while enabling deployment in response to floodwater accumulation.

As illustrated in FIG. 15B, the vault 104 features an upper gutter integrally formed along the interior sidewalls near the vault opening. This gutter is configured to intercept runoff and surface water from above and redirect it to calibrated orifices. The orifices may be cylindrical or tapered or are dimensioned to restrict flow, thereby regulating the volume and rate of water entering the panel activation chamber. Their size and placement allow the system to discriminate between transient rainfall and sustained flood conditions. A sloped gutter profile may be implemented to facilitate water movement and prevent stagnation. Protective grates or mesh screens may be integrated over the orifices to prevent obstruction from leaves or debris, ensuring reliable actuation performance over time.

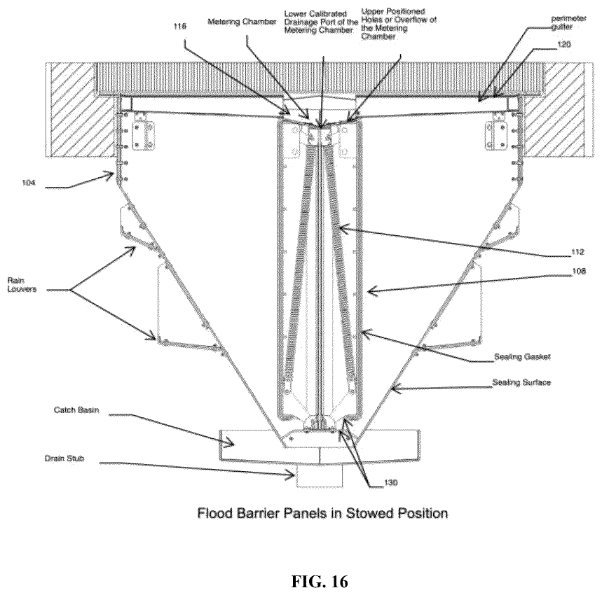

FIG. 16 presents an perspective of the vault 104 and its internal components. The movable panel 108 is shown coupled to pivot mounts positioned along opposing interior sidewalls of the vault, with the counterbalance mechanism 112 seated beneath or adjacent to the pivot axis. The counterbalance mechanism 112 may include one or more weighted arms, torsion springs, tension springs, dampers, or sealed fluidic chambers, each tuned to bias the panel toward its stowed orientation while permitting passive deployment once a threshold force is applied. The vault interior geometry accommodates component nesting to maintain a compact footprint and may include service access panels or removable covers to facilitate installation and maintenance. The system may be pre-assembled for plug-and-play installation or delivered in modular segments for assembly at the deployment site, allowing flexibility in procurement and field logistics.

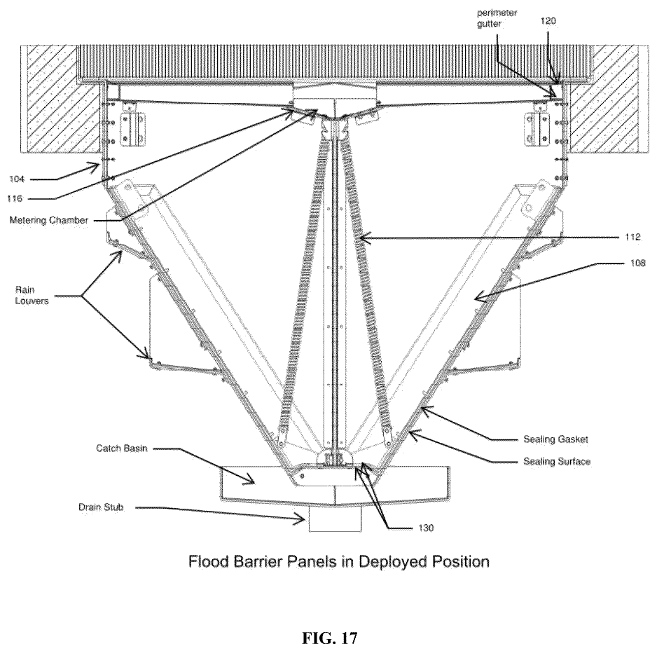

In FIG. 17, the panel 108 is depicted in a deployed orientation. The gutter is visible along the upper vault interior, while ports within the metering chamber allow controlled water ingress into the internal cavity of the panel. These ports are engineered to introduce a timed delay, requiring accumulation of water before actuation occurs. When water fills the metering chamber to a predetermined level it is enabled to enter the movable panel, where the resulting weight of the movable panel and the water within it creates a moment that overcomes the counterbalancing force, causing the panel to rotate downward under gravity and hydrostatic pressure. This passive actuation strategy ensures that the panel does not respond to brief weather fluctuations and only triggers under persistent flooding scenarios.

FIG. 16 shows the flood barrier system 100 in a fully stowed configuration. A grated surface is mounted flush with the surrounding grade above the vault 104. This grating may allow vehicular or pedestrian traffic to pass over the underground water opening, while allowing rainwater and air to pass through while preventing larger debris from entering the vault. The design ensures that the panel 108 and vault components remain protected during regular use of the area. The panel 108 is supported vertically within the vault cavity, retained in position by mechanical stops or brackets, and biased upright by the internal counterbalance 112. The grated cover blends with the streetscape and ensures that the system poses no tripping or vehicular hazard.

Turning to FIG. 17, the system is shown in its fully deployed state. The panel 108 has rotated outward from the vault 104 to form a sealed barrier against oncoming floodwater. The interface between the panel and vault sidewalls or floor may be shaped to form a mechanical seal using close-contact surfaces, compressible gaskets, or interlocking geometries. Hydrostatic pressure from rising water maintains the panel in its deployed position, ensuring a secure seal. Once floodwaters recede, drainage apertures within the vault permit water to exit, reducing internal pressure. The counterbalance mechanism 112 then gradually returns the panel to its vertical orientation without requiring manual reset. The system is designed to complete this full cycle stow, deploy, drain, reset—without external input, electrical power, or specialized tools.

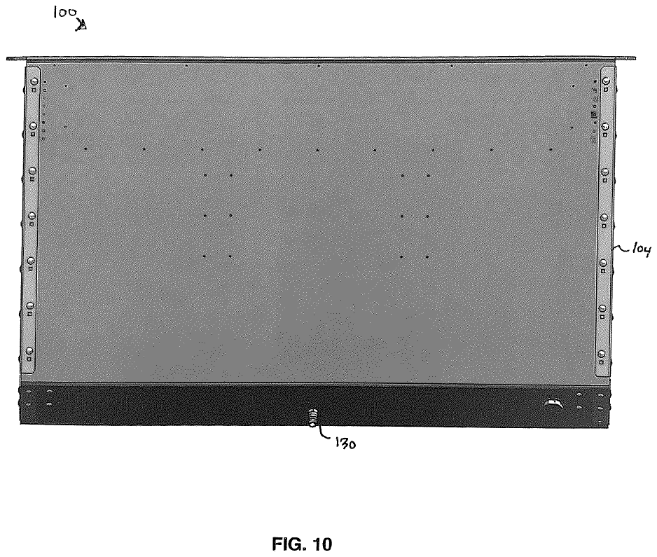

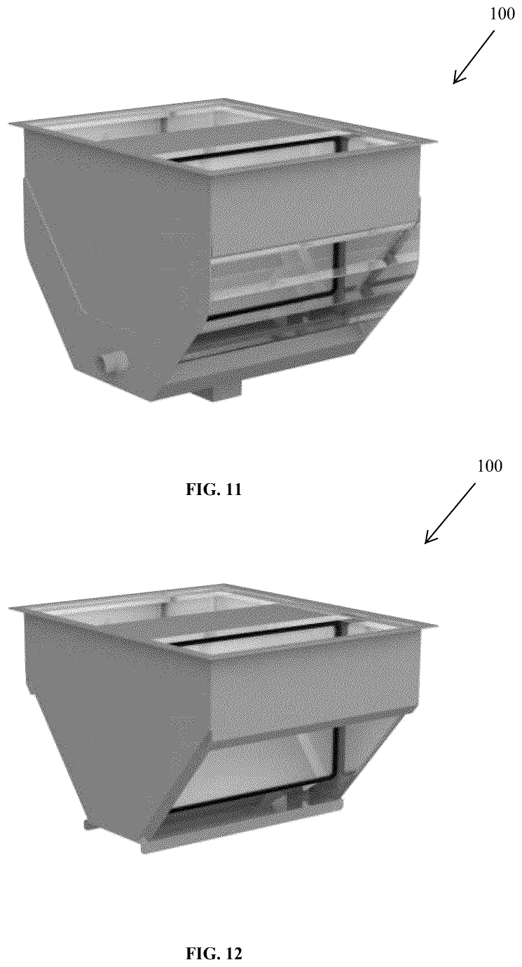

As shown in FIG. 11, the flood barrier system 100 may be integrated with louvers, a catch pan or containment basin positioned below the passive flood barrier. The containment basin may receive and channel overflow water to a secondary drainage pathway, such as a side-mounted outlet or bottom drain to strategically route away unwanted water that passes through the flood barrier opening.

Referring now to FIG. 12, an alternative embodiment of the flood barrier system 100 is shown, wherein the passive flood barrier assembly is configured without an integrated catch basin. In this configuration, the flood barrier assembly may be directly mounted over an existing ventilation or drainage aperture or recessed region of a structural surface. A grating element may be positioned above the assembly to allow for normal water flow during non-flood conditions. The passive flood barrier assembly may be enclosed within a perimeter housing that aligns with a pre-formed depression in the surrounding structure. This configuration allows for simplified installation in retrofitted applications where an existing ventilation, drainage, or scupper port is already present.

In FIG. 13, an isometric view is provided to illustrate the assembled flood barrier system with louvers and an integrated catch basin and superimposed semi-transparent surrounding structure. The surrounding boundary layer may represent an existing architectural or civil element, such as a sidewalk, plaza, or rooftop surface. The grating may be positioned flush with the surrounding structure and may serve both to obscure the flood barrier from view and to prevent large debris from entering the mechanism. The entire system may operate without electrical power or mechanical actuation, relying instead on hydrostatic activation.

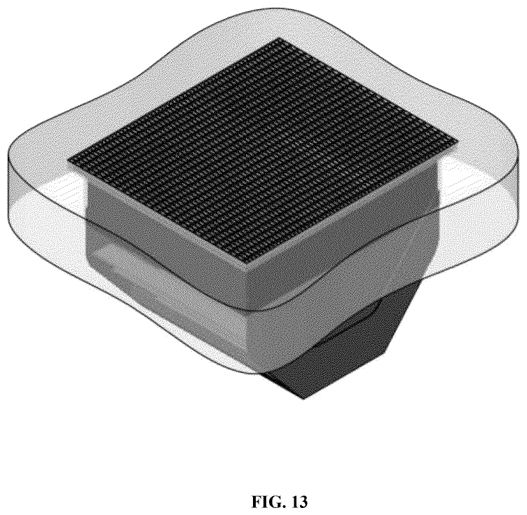

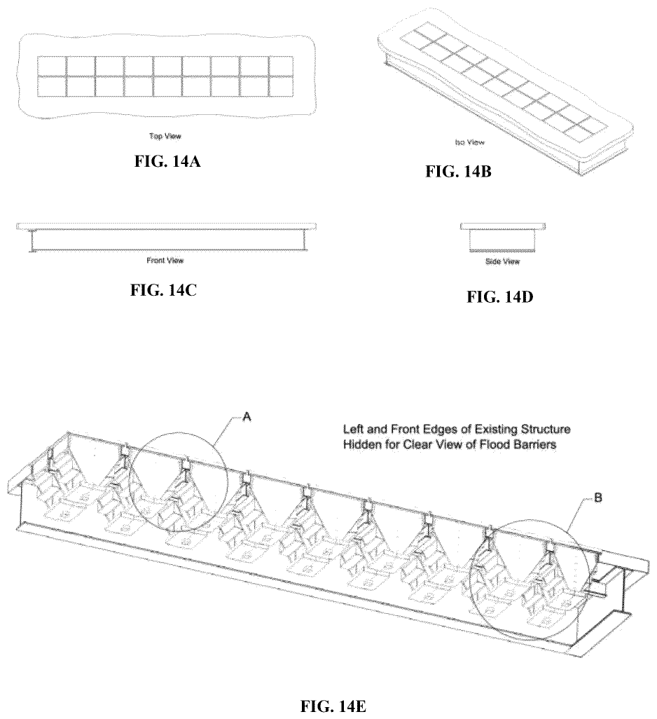

Turning to FIGS. 14A through 14D, a raised modular flood barrier configuration is illustrated in the context of an elevated deck or bridge installation. As shown in the top view of FIG. 14A and the isometric perspective of FIG. 14B, a plurality of discrete flood barrier systems may be arranged in a linear or longitudinal configuration across the surface of the deck. Each system may house an array of buoyant flood barrier modules that are configured to deploy in response to rising or overland floodwaters. The systems may be positioned adjacent to one another to form a continuous protective span and may be oriented parallel to the edge of the structure to intercept lateral water flow. The deck may be supported by one or more longitudinal girders, which may provide structural reinforcement and may define internal cavities suitable for drainage routing or passive overflow discharge.

As further shown in the front and side views of FIGS. 14C and 14D, the front and side views also illustrate the relative profile and uniformity of the panel geometry, which may be designed for modular compatibility and streamlined installation across different sections of an elevated deck. This configuration may be particularly applicable to transportation infrastructure, such as bridges, overpasses, or causeways, where passive, self-deploying flood mitigation is required to preserve functionality during flash flooding or tidal surge events.

After the threat of flooding has passed and water levels recede, the self-resetting mechanism 130 initiates. This mechanism utilizes the natural gravitational flow of water to facilitate the retraction of the movable panels 108. Integrated drainage channels help expedite this process by channeling residual water away from the barrier, ensuring that the panels can return smoothly to their original positions without manual intervention. This automatic reset feature is essential for maintaining the readiness of the system for subsequent flooding events, providing continuous protection with minimal maintenance requirements.

As flood waters enter the underground opening, the passive flood barrier system directs intruding flood water into the water flow regulation system. In one example, flood water is directed to the water flow regulation system by means of a gutter system around at least a portion of the perimeter of the passive flood barrier assembly. The debris management system is important to filter out solid debris brought in with intruding flood water to ensure that debris does not affect the deployment mechanism or require more frequent maintenance and cleaning of the passive flood barriers system. Debris is filtered out of the intruding water before it enters the critical mechanisms that facilitate deployment of the flood barrier. In one example the debris management system is located over the gutter system to preclude debris intruding into the gutter and the downstream mechanisms. In another example the debris management system can be located at the water flow regulation system to exclude debris from entering that system or the metering chamber and the mechanisms downstream of it. In another example, a debris management system could be located at opening of the movable panel to prevent debris from getting within the movable panel reservoir volume.

In some embodiments, the passive flood barrier is designed with very few horizontal surfaces to reduce the potential for debris to bench or accumulate on. The sloped surfaces of the passive flood barrier system help the system self-flush debris, specifically the deployment mechanisms and the gasket sealing surface on the barrier assembly housing.

In some embodiments, the self-resetting mechanism may include a drainage pathway that is located in the lower portion of the movable panel or the lower portion of the barrier assembly housing, or both. In another example, the drainage pathway in the movable panel can be located so that it drains into the barrier assembly housing so it does not create an unwanted leakage pathway through the flood barrier panel during a flooding event. In another example the drainage pathway may be located in the lower portion of the movable panel so that the leakage pathway may drain both the movable panel and the barrier assembly housing simultaneously. In another aspect, the drainage pathways of the self-resetting mechanism 130 may be directed into a drain pipe, gutter, or routed away.

Considering various environmental and infrastructural needs, multiple alternate embodiments of the passive flood barrier system can be developed. For urban areas with aesthetic or space constraints, the movable panels could be designed with transparent materials or custom finishes that blend into the historical or architectural context. In regions prone to heavy debris flow, the debris management system might include more robust and complex filtering mechanisms, capable of handling larger objects or higher volumes of sediments.

Another alternate embodiment could involve integrating advanced sensor technology to enhance the predictive capabilities of the water flow regulation system. These sensors would not only detect water levels but also analyze the rate of water rise, adjusting the deployment of the panels more dynamically to the severity of the flood threat. Additionally, for expansive flood plains or variable terrain, modular sections of the barrier could be interconnected, allowing for scalable coverage that can be adjusted as per the topographical requirements.

The detailed design and operational efficiency of the passive flood barrier system mark a significant step forward in flood management technology. This system not only provides robust, reliable flood defense but also offers flexibility in deployment and minimal impact on the daily use of space. Its ability to automatically deploy in response to flooding conditions and reset itself afterward minimizes the need for human intervention, making it an ideal solution for enhancing urban resilience against flooding. Future developments might incorporate more sophisticated technologies, such as AI-driven predictive models and automated maintenance protocols, to further increase the system's efficacy and reduce the urban footprint. Through its innovative design and adaptive capabilities, this flood barrier system promises to safeguard communities while supporting sustainable urban development.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A passive flood barrier system for protecting an underground opening from flooding while allowing access or airflow under non-flood conditions, the system comprising:
a barrier assembly configured to cover the underground opening, the barrier assembly including at least one movable panel configured to transition between a stowed position during non-flood conditions and a deployed position during a flood event to form a seal over the underground opening;
a counterbalancing mechanism operatively connected to the movable panel, the counterbalancing mechanism configured to retain the movable panel in the stowed position and permit deployment in response to water accumulation in the movable panel exceeding a predefined threshold;
a water flow regulation system configured to control water entry into the movable panel, wherein the water flow regulation system allows water into the movable panel when water intrusion exceeds a predefined threshold while preventing premature activation due to minor water intrusion;
a self-resetting mechanism configured to return the movable panel from the deployed position to the stowed position after floodwaters recede, restoring airflow through the underground opening; wherein
the passive flood barrier system operates without external power or manual intervention, utilizing the weight of accumulated water to activate deployment and a restoring force to facilitate reset after the flood event.

2. The passive flood barrier system of claim 1, wherein the movable panel is pivotally mounted to the barrier assembly to rotate between the stowed position and the deployed position.

3. The passive flood barrier system of claim 2, wherein the counterbalancing mechanism comprises a calibrated resistance system that allows deployment of the movable panel as accumulated water weight increases.

4. The passive flood barrier system of claim 3, wherein the counterbalancing mechanism includes at least one spring, counterweight, or torsion component configured to regulate panel movement, and further wherein the counterbalancing mechanism enables stowage of the movable panel as accumulated water weight decreases.

5. The passive flood barrier system of claim 1, wherein a water flow regulation system controls water entry into the movable panel, wherein water intruding into the underground opening passes through the water flow regulation system and is diverted away from the movable panel until the intruding water exceeds a rate which warrants deployment of the movable panel, at which point water is diverted into the movable panel.

6. The passive flood barrier system of claim 5, wherein the water flow regulation system includes a metering chamber with at least one orifice, baffle, weep hole, flow control valve, or controlled water outlet to delay deployment until a sufficient flow rate of intruding flood water has been exceeded.

7. The passive flood barrier system of claim 6, wherein the metering chamber contains a reservoir volume where entering flood water is diverted away from the movable panel through at least one lower positioned calibrated drainage port consisting of an orifice, baffle, weep hole, or flow control valve until the rate of entering flood water exceeds the drainage port flow rate causing water accumulation in the reservoir volume where it is enabled to divert to the movable panel to facilitate deployment via upper positioned holes or overflow of the metering chamber volume.

8. The passive flood barrier system of claim 1, wherein a debris management system is integrated with the barrier assembly, the debris management system comprising a filtering structure configured to direct or filter solid debris away from the movable panel or waterflow regulation system.

9. The passive flood barrier system of claim 8, wherein the filtering structure includes a mesh screen, perforated plate, or sediment diversion channel divert most solid debris away from the water flow regulation system, movable panel, or gutter system.

10. The passive flood barrier system of claim 1, wherein the movable panel, in the deployed position, forms a substantially watertight seal with a sealing interface.

11. The passive flood barrier system of claim 10, wherein the sealing interface comprises a compressible gasket, wiper seal, blade seal, or lip seal.

12. The passive flood barrier system of claim 1, wherein the self-resetting mechanism includes a drainage pathway configured to facilitate removal of residual water after the flood event.

13. The passive flood barrier system of claim 12, wherein the drainage pathway comprises at least one weep hole, siphon, or controlled discharge outlet in the movable panel.

14. The passive flood barrier system of claim 13, wherein the drainage pathway comprises at least one additional weep hole, siphon, or controlled discharge outlet in the barrier assembly housing.

15. The passive flood barrier system of claim 1, wherein there are multiple movable panels.

16. The passive flood barrier system of claim 15, wherein the multiple movable panels are interconnected such that deployment of one panel triggers deployment of at least one adjacent panel.

17. The passive flood barrier system of claim 15, wherein the multiple movable panels are interconnected and linked via a mechanical linkage, fluid transfer system, or synchronized buoyant activation mechanism.

18. The passive flood barrier system of claim 1, wherein the barrier assembly is configured to be modular, allowing for installation over openings of various shapes and sizes.

19. The passive flood barrier system of claim 1, wherein the barrier assembly is constructed from corrosion-resistant materials, including stainless steel, aluminum, or polymer composites.

20. The passive flood barrier system of claim 1, wherein a debris management system integrated with the barrier assembly, the debris management system configured to direct or filter solid debris away from the movable panel.

21. A passive flood barrier system for protecting an underground opening from flooding while allowing access or airflow under non-flood conditions, the system comprising:
a barrier assembly configured to cover the underground opening, the barrier assembly including at least one movable panel configured to transition between a stowed position during non-flood conditions and a deployed position during a flood event to form a seal over the underground opening;
a counterbalancing mechanism operatively connected to the movable panel, the counterbalancing mechanism configured to retain the movable panel in the stowed position and permit deployment in response to water accumulation in the movable panel exceeding a predefined threshold;
a water flow regulation system integrated into the movable panel, the water flow regulation system including a lower positioned drainage port in the movable panel configured to permit evacuation of water entering the panel so as to inhibit deployment under low-flow conditions;
a self-resetting mechanism configured to return the movable panel from the deployed position to the stowed position after floodwaters recede, restoring airflow through the underground opening; wherein
the passive flood barrier system operates without external power or manual intervention, utilizing the weight of accumulated water to activate deployment and a restoring force to facilitate reset after the flood event.

22. The flood barrier of claim 21, wherein the movable panel includes a drainage port restriction device configured to partially or fully restrict a drainage port when the movable panel rotates to a deployed position.

23. The flood barrier of claim 22, wherein the drainage port restriction device is configured to retain water within the movable panel for an extended duration after deployment.

24. The flood barrier of claim 22, wherein the drainage port restriction device is formed by a portion of a barrier assembly housing, frame, or sealing interface that covers or obstructs the drainage port as the movable panel rotates to the deployed position.

25. A passive flood barrier system for protecting an underground opening from flooding while allowing access or airflow under non-flood conditions, the system comprising:
a barrier assembly configured to cover the underground opening, the barrier assembly including at least one pivotally mounted movable panel configured to transition between a stowed position during non-flood conditions and a deployed position during a flood event to form a seal over the underground opening;
a counterbalancing mechanism operatively connected to the movable panel, the counterbalancing mechanism including at least one spring or counterweight configured to resist movement of the movable panel until the force exerted by accumulated floodwater exceeds a predetermined threshold;
a water flow regulation system including a metering chamber configured to control water entry into the movable panel, the metering chamber having at least one orifice, baffle, or controlled discharge outlet to delay deployment of the movable panel until sufficient water accumulation occurs; and
a self-resetting mechanism including a drainage pathway configured to facilitate removal of residual water, allowing the counterbalancing mechanism to return the movable panel to the stowed position after floodwaters recede; wherein
the passive flood barrier system operates without external power or manual intervention, utilizing the weight of water for activation and a restoring force to facilitate reset after the flood event.

26. The passive flood barrier system of claim 25, wherein the spring is a tension spring attached on the upper portion of the barrier assembly housing.

27. The passive flood barrier system of claim 25, wherein the counterweight mechanism includes a pulley.

28. A passive flood barrier system for protecting an underground opening from flooding while allowing airflow under non-flood conditions, the system comprising:
a barrier assembly configured to cover the underground opening, the barrier assembly including at least one pivotally mounted movable panel that transitions between a stowed position permitting airflow and a deployed position forming a substantially watertight seal over the underground opening;
a counterbalancing mechanism including at least one spring or torsion element configured to resist deployment of the movable panel until the weight of accumulated water overcomes a predefined resistance threshold;
a water flow regulation system including a metering chamber with at least one calibrated orifice configured to divert intruding water away from the movable panel until a sufficient rate of water enters the metering chamber;
a debris management system including a mesh screen configured to divert debris away from the deployment mechanism;
a self-resetting mechanism including a controlled drainage system with at least one weep hole, siphon, or discharge outlet allowing water to gradually drain and enabling the counterbalancing mechanism to return the movable panel to the stowed position without manual intervention;
the barrier assembly is constructed from corrosion-resistant materials, including stainless steel, aluminum, or polymer composites; and
the passive flood barrier system operates without requiring external power or manual intervention, relying solely on passive mechanical forces for deployment and reset.
